(19) United States
(12) Patent Application Publication
(10) Pub. No.: US 2006/0026996 A1
(43) Pub. Date: Feb. 9, 2006

(54) Ceramic mold with carbon nanotube layer

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/196,537

(22) Filed: Aug. 3, 2005

(30) Foreign Application Priority Data
Aug. 4, 2004 (CN) 200410051009.1

(51) Int. Cl. C03B 11/08

(52) U.S. Cl. 65/374.13; 65/374.15

(57) ABSTRACT

A ceramic mold (10 or 10′) includes a ceramic substrate (11 or 11′) having a film surface (110 or 110′), a function layer (12 or 12′) formed on the film surface of the ceramic substrate. The function layer comprises a plurality of carbon nanotubes. The ceramic substrate is made of a material selected from the group consisting of WC, BNC, SiC and Si₃N₄. The carbon nanotubes may be single-walled carbon nanotubes, multi-walled carbon nanotubes, or substrate-array carbon nanotubes. A thickness of the function layer may be in the range from 20 to 200 nanometers, and is preferably in the range from 50 to 100 nanometers.

### BACKGROUND OF THE INVENTION

1. Technical Field

The present invention relates generally to a mold device, and more specifically to a ceramic mold with a function layer.

2. Related Art

The relatively recent technique of manufacturing a lens by press-molding of a glass material without requiring a polishing process has become commonplace. This technique eliminates the complicated steps of conventional polishing which were previously required in the manufacturing. It is now possible to make a lens simply and inexpensively by employing the technique. The technique has recently been used not only in the manufacture of lenses, but also other optical pieces made of glass such as prisms.

A mold used for the press-molding of glass optical pieces should have characteristics such as excellent hardness, high heat resistance, easy separability, mirror surface workability, etc. Numerous materials have been used as coatings for such molds, in order to provide or enhance these characteristics. Such materials include various metals and ceramics.

For example, 13 Cr martensite steel can be used as a coating. However, this material suffers from the disadvantages that: (i) it is easily oxidized; and (ii) the Fe in the material diffuses in glass at high temperatures, thereby coloring the glass. SiC and Si₃N₄ are generally regarded as being resistant to oxidation. Nevertheless, these two materials are still liable to be oxidized at high temperatures. When this happens, a film of SiO₂ is formed on the surface of the coating, and this causes fusion with the glass material. Further, the workability of the mold itself is poor, due to the high hardness of SiC and Si₃N₄. A coating with a precious metal resists fusion. However, precious metals tend to br very soft, and the coating is easily damaged or deformed.

A mold coated with any of various carbon films has been proposed. Such carbon films can be broadly categorized, according to their crystal structures, into the following types: (i) a diamond polycrystalline film; (ii) a graphite film or a glassy carbon film having crystalline properties; (iii) a diamond-like carbon film comprising a diamond crystallite phase and an amorphous phase; and (iv) a carbon film of high hardness, composed of amorphous or microcrystalline (an aggregate of crystallites) carbon comprising SP2- and SP3-hybrided carbon.

The diamond polycrystalline film of item (i) has high surface hardness, no fusion with molded glass, as well as low reactivity. However, being a polycrystalline film, it is liable to have high surface roughness, and the process of polishing the film surface tends to be problematic. The graphite film or the glassy carbon film of item (ii) has low hardness and structural strength, and poor resistance to oxidation at high temperatures. Such film is liable to develop surface roughness and to deteriorate.

Japanese Laid-Open Patent Application No. 63-203222 discloses a diamond-like carbon film made by using a plasma chemical vapor deposition (PCVD) method under relatively high substrate temperature conditions. This film is a kind of diamond-like carbon film containing a diamond crystal phase, and belongs to item (iii). The film is non-homogeneous in quality, and it is therefore difficult to obtain a uniform surface with high smoothness. In addition, when the film surface is oxidized little by little with each molding process performed, the oxidization is generally non-uniform, and deterioration and surface roughness is apt to occur relatively rapidly. Moreover, further crystallization of the film is liable to occur at high temperatures. The quality of the film deteriorates, and its hardness and adhesion to the mold body are weakened.

A method using a diamond-like carbon film is disclosed in Japanese Laid-Open Patent Application No. 61-183134. The diamond-like carbon film is an amorphous film comprising SP2 carbon and SP3 carbon. In fact, it is difficult to clearly distinguish whether the diamond-like carbon film is a glassy carbon film belonging to item (ii), or an amorphous carbon film chiefly comprising SP2 carbon belonging to item (iv). Therefore, hereinafter, as regards a carbon film of high hardness composed of amorphous or micro crystalline carbon comprising SP2- and SP3-hybrided carbon, the following conventions regarding terminology will be used. A film containing a small amount of hydrogen in its composition will be referred to as a hard carbon film. A film containing hydrogen of a certain threshold concentration or a concentration greater than the threshold concentration will be referred to as a hydrogenated amorphous carbon film (a-C:H film).

An optical piece molding mold disclosed in U.S. Pat. No. 5,202,156 is for heating, pressing, and press-molding a glass blank. At least the film surface of the mold is coated with a carbon film. A method of manufacturing such mold is also disclosed. An a-C:H film or a hard carbon film is formed on the film surface of one or more mold base materials. The film contacts a glass blank that is to be molded. However, the a-C:H film or hard carbon film is easily damaged or even destroyed under conditions of high temperature and high pressure in the molding process.

What is needed, therefore, is a ceramic mold with strong wear resistance, high rigidity, and a long working lifetime.

### SUMMARY

In a preferred embodiment, the present invention provides a ceramic mold. The ceramic mold includes a ceramic substrate having a film surface and a function layer formed on the film surface of the ceramic substrate. The function layer comprises a plurality of carbon nanotubes.

The ceramic mold may be an upper mold or a lower mold. The ceramic substrate is made of a material selected from the group consisting of WC, BNC, SiC or Si₃N₄. The carbon nanotubes may be single-walled carbon nanotubes, multi-walled carbon nanotubes or substrate-array carbon nanotubes. A thickness of the function layer may be in the range from 20 to 200 nanometers, and is preferably in the range from 50 to 100 nanometers. The function layer can tolerate high pressures of 10,000 Newton and high temperatures of 700 degrees Centigrade. Therefore a working lifetime of the ceramic mold is increased, even to a range of from 100,000 to 1 million cycles.

The function layer may be formed by a chemical vapor deposition process, arc-discharge process, laser ablation process, or reactive sputtering process.

Therefore the preferred embodiment provides a ceramic mold with strong wear resistance, high rigidity, and a long working lifetime.

### BRIEF DESCRIPTION OF THE DRAWINGS

FIG. 1 is a schematic, cross-sectional view of a ceramic mold in accordance with a preferred embodiment of the present invention, showing the mold before press-molding of a glass blank is performed.

FIG. 2 is similar to FIG. 1, but showing the mold during press-molding of the glass blank.

FIG. 3 is an enlarged view of a circled portion III of FIG. 2.

### DETAILED DESCRIPTION OF THE PREFERRED EMBODIMENTS

Reference will now be made to the drawings to describe the preferred embodiment of the present invention in detail.

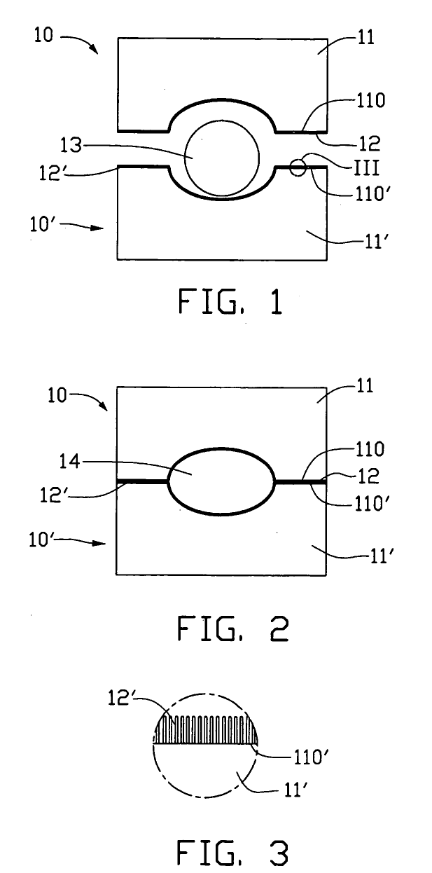

Referring to FIGS. 1 and 2, a working piece like a mold of a preferred embodiment of the present invention comprises a ceramic upper mold 10 and a ceramic lower mold 10′. The upper mold 10 includes a first ceramic substrate 11, which has a first film surface 110. A first function layer 12 is formed on the first film surface 110. The lower ceramic mold 10′ includes a second ceramic substrate 11′, which has a second film surface 110′. A second function layer 12′ is formed on the second film surface 110′. The first film surface 110 is opposite to the second film surface 110′. The first and second ceramic substrates 11, 11′ are made of a material selected from the group consisting of WC, BNC, SiC, and Si₃N₄. A shape of the first film surface 110 of the first ceramic substrate 11 may or may be not the same as that of the second film surface 110′ of the second ceramic substrate 11′. The shape of the first film surface 110 and/or the second film surface 110′ may be spherical or aspherical, according to need. In the illustrated embodiment, the first film surface 110 and the second film surface 110′ have the same aspherical shape, for making an optical piece 14. After heating, pressing and press-molding a glass blank 13, a desired optical piece 14 is obtained.

Referring to FIG. 3, the first function layer 12 is formed of a plurality of carbon nanotubes provided on the first film surface 110 of the first ceramic substrate 11. The second function layer 12′ is formed of a plurality of carbon nanotubes provided on the second film surface 110′ of the second ceramic substrate 11′. The function layers 12, 12′ may be formed by a chemical vapor deposition (CVD) process, arc-discharge process, laser ablation process, or reactive sputtering process. The carbon nanotubes may be single-walled carbon nanotubes, multi-walled carbon nanotubes, or substrate-array carbon nanotubes. A thickness of the function layers 12, 12′ may be in the range from 20 to 200 nanometers, and is preferably in the range from 50 to 100 nanometers. The function layers 12, 12′ can tolerate high pressures of 10,000 Newton and high temperatures of 700 degrees Centigrade. Therefore, a working lifetime of the ceramic molds 10, 10′ is increased, even to a range of from 100,000 to 1 million cycles. The function layers 12, 12′ are able to be directly deposited onto the substrate 11, 11′ by means of the Chemical Vapor Deposition (CVD) process, the Arc Discharge process, the Laser Ablation process or the reactive sputtering process without using any metal catalyst like Ni, C., Fe films, etc.

While embodiments of the present invention are described and illustrated, various modifications and improvements can be made by persons skilled in the art. The embodiments are intended to be described in an illustrative and not a restrictive sense. It is intended that the present invention not be limited to the particular forms as illustrated, and that all modifications which maintain the spirit and realm of the present invention are within the scope as defined in the appended claims.

What is claimed is:

1. A ceramic mold comprising:
a ceramic substrate having a film surface; and
a function layer provided on the film surface;
wherein the function layer comprises a plurality of carbon nanotubes.

2. The ceramic mold as claimed in claim 1, wherein the ceramic mold is selected from the group consisting of a ceramic upper mold and a ceramic lower mold.

3. The ceramic mold as claimed in claim 1, wherein the ceramic substrate is made of a material selected from the group consisting of WC, BNC, SiC and Si₃N₄.

4. The ceramic mold as claimed in claim 1, wherein a thickness of the function layer is in the range from 20 to 200 nanometers.

5. The ceramic mold as claimed in claim 1, wherein the carbon nanotubes are selected from the group consisting of single-walled carbon nanotubes, multi-walled carbon nanotubes and substrate-array carbon nanotubes.

6. The ceramic mold as claimed in claim 1, wherein the function layer is formed by a process selected from the group consisting of chemical vapor deposition, arc-discharge, laser ablation, and reactive sputtering.

7. A method to manufacture a mold, comprising the steps of:
preparing a substrate as a main part of said mold;
defining a surface at a side of said substrate to perform molding of said mold; and
forming a layer of carbon nanotubes on said surface so as to acquire said mold.

8. The method as claimed in claim 7, wherein said layer of carbon nanotubes is formed on said surface by means of one of a Chemical Vapor Deposition (CVD) process, an Arc Discharge process, a Laser Ablation process and a reactive sputtering process without using any metal catalyst.

9. A method to manufacture a working piece used for a predetermined function, comprising the steps of:
preparing a substrate as a main part of said working piece;
defining a surface at a side of said substrate to perform said predetermined function of said working piece; and
forming a layer of carbon nanotubes on said surface without using any catalyst.

10. The method as claimed in claim 9, wherein said working piece is a mold for making optical pieces and said predetermined function is molding.

11. The method as claimed in claim 9, wherein one of a Chemical Vapor Deposition (CVD) process, an Arc Discharge process, a Laser Ablation process and a reactive sputtering process is used in said forming step to form said layer of carbon nanotubes.
